(19) United States
(12) Patent Application Publication
(10) Pub. No.: US 2014/0096230 A1
(43) Pub. Date: Apr. 3, 2014

(54) METHOD AND SYSTEM FOR SHARING VPN CONNECTIONS BETWEEN APPLICATIONS

(71) Applicant: OpenPeak Inc., Boca Raton, FL (US)

(72) Inventor: Christopher Michael Wade, Delray Beach, FL (US)

(21) Appl. No.: 14/036,415

(22) Filed: Sep. 25, 2013

Related U.S. Application Data
(60) Provisional application No. 61/705,474, filed on Sep. 25, 2012.

(51) Int. Cl. H04L 29/06

(52) U.S. Cl. CPC H04L 63/0272
USPC 726/15

(57) ABSTRACT

A method for sharing a virtual private network (VPN) connection among applications is described herein. In an environment in which multiple applications exchange data through the use of the virtual file system, a VPN for a first application can be established, and it can be determined that the first application is deactivated. Upon the determination that the first application is deactivated, a state of the VPN can be saved in a shared memory through the virtual file system. It may also be determined that a second application is activated. A VPN connection can be established for the second application by resuming the saved VPN state through the virtual file system.

### CROSS-REFERENCE TO RELATED APPLICATIONS

This patent application claims priority to U.S. Patent Application No. 61/705,474, filed on Sep. 25, 2012, which is herein incorporated by reference in its entirety.

### FIELD OF TECHNOLOGY

The present description relates to methods and systems for enabling VPN connections for applications and more particularly, for enabling the sharing of VPN connections among applications.

### BACKGROUND

In an effort to increase productivity, many employers allow their workers to conduct business related to the employer on their personal mobile devices. In some cases, employers also provide some of their employees with company-issued mobile devices. In either arrangement, an employer understands that a single device may include sensitive data related to that employer in addition to data that is personal to the employee. Several advances have been made in an effort to protect an employer's data in these circumstances. For example, OpenPeak Inc. of Boca Raton, Fla. has developed solutions that enable a mobile device to include both enterprise and personal data but that isolate the enterprise data from the personal data. As part of these solutions, an employee may download secure applications that may be used to conduct transactions related to the enterprise, but these secure applications are prevented from exchanging data with conventional or non-secure applications.

As further protection for confidential enterprise data, some employers may require their employees to use virtual private network (VPN) connections when working remotely. In some operating environments, a system-level VPN may be provided, and all applications on a device may rely on this connection to conduct secure communications. In some cases, however, it may not be desirable to force secure applications to use this particular VPN connection. That is, an enterprise may wish to have secure applications that are installed on its behalf and which will access its data to avoid using a VPN connection that is open to non-secure applications.

Even if a viable solution can be determined for providing a safer VPN connection for secure applications, other obstacles exist for efficiently doing so. Specifically, the steps involved in setting up a VPN connection are time consuming and may be complicated. Moreover, an employee-end user would prefer to avoid having to constantly or even periodically set up VPN connections when dealing with secure applications. Thus, a need exists for providing a safe, reliable and convenient VPN connection for secure applications.

### SUMMARY

A method for sharing a VPN connection among applications is described herein. In particular, in an environment in which multiple applications exchange data through the use of the virtual file system, a VPN can be established for a first application. It can be determined that the first application is deactivated, and upon the determination that the first application is deactivated, a state of the VPN can be saved in a shared memory through the virtual file system. It can be determined that a second application is activated, and a VPN connection for the second application can be established by resuming the saved state of the VPN through the virtual file system. By resuming the saved VPN state, the second application is not required to perform a VPN initiation process.

In one arrangement, the shared memory can be a pasteboard that is accessible by the first and second applications, and the virtual file system may be imposed over the pasteboard. As another example, the first application and the second application can be unrelated secure applications.

In another arrangement, establishing the VPN for the first application and establishing the VPN for the second application can include establishing the VPN for the first application and establishing the VPN for the second application on a per-application basis. Further, calls originally intended for a system-level VPN can be redirected to a first VPN module of the first application when the VPN for the first application is established and to a second VPN module of the second application when the VPN for the second application is established.

In another embodiment, the VPN state can be encrypted prior to saving the VPN state in the shared memory. An encryption key can be generated for encrypting the VPN state prior to saving the VPN state in the shared memory, and the encryption key can be shared with the second application to enable the second application to decrypt the saved VPN state.

Another method of sharing a VPN connection among applications is described herein. In this method, the VPN connection is established from a first application to a server, and packet data can be redirected to a VPN module that is part of the first application to enable communications over the VPN connection from the first application to the server. In addition, a state of the VPN can be saved in a shared memory when the first application is deactivated, and a VPN connection can be established for a second application by resuming the saved VPN state. Packet data may also be redirected to a VPN module that is part of the second application to enable communications over the VPN connection from the second application.

As an example, the first application and the second application can be secure applications. In one embodiment, the first application may be a secure application, and establishing the VPN connection for the second application further includes establishing the VPN connection for the second application by resuming the saved VPN state only if the second application is a secure application. As another example, the shared memory can be a pasteboard, and a virtual file system can be imposed over the pasteboard. The state of the VPN can also be encrypted prior to storing the state of the VPN in the shared memory.

A computing device that supports per-application VPNs is also described herein. The device can include an interface that can be configured to support a VPN connection to a server and a shared memory that may be accessible by a first application and a second application that are both installed on the computing device. Additionally, the shared memory can be configured to store a VPN state when the first application is deactivated, and the VPN state may be related to a VPN connection for the first application. The shared memory can be further configured to provide the stored VPN state to the second application when the second application is activated and a VPN connection for the second application is to be established.

The computing device may also include an encryption engine that can be configured to encrypt the VPN state prior to the VPN state being stored in the shared memory. As an example, the shared memory of the computing device can be a pasteboard, and a virtual file system may be imposed over the pasteboard. The first and second applications can use the virtual file system to access the pasteboard.

As another example, the first and second applications may be secure applications, and the computing device can be configured to isolate the secure applications from non-secure applications. The first and second applications, in one arrangement, may be unrelated applications. The computing device may also be a processing unit that can be configured to enable packet data to be redirected to a VPN module that is part of the first application when the VPN connection is established for the first application and to a VPN module that is part of the second application when the VPN connection is established for the second application.

Another method of providing a VPN on a per-application basis is described herein. The method can include the steps of launching a first application on a computing device, establishing a VPN connection for the first application through a VPN module that is part of the first application and deactivating the first application. The method can also include the steps of launching a second application on the computing device, establishing a VPN connection for the second application through a VPN module that is part of the second application and as part of establishing the VPN connection for the second application, using the state of the VPN associated with the first application.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system that can enable the sharing of a VPN connection among applications.

FIG. 2 illustrates an example of a representation of data and key exchanges among applications using a virtual file system and a shared memory.

FIG. 3 illustrates an exemplary representation of a securitization process.

FIG. 4 illustrates an example of a method for enabling the sharing of a VPN connection among applications.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described. The term “among,” as it is used throughout this description, should not necessarily be interpreted as requiring exchanges or interaction among three or more applications, irrespective of grammar rules.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “computer program medium” and “computer readable medium” are defined as one or more non-transitory components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment that may not present a user interface while in the background. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. The term “shared memory” is memory or a memory element that is accessible (directly or indirectly) by two or more applications or other processes. A “paste memory element” or a “pasteboard” is defined as a memory element that is configured to receive data from a first application or first component (directly or indirectly) for possible eventual retrieval by that first application, first component or a second application or second component. An “interface” is defined as a component or a group of components that enable(s) a device to communicate with one or more different devices, whether through hard-wired connections, wireless connections or a combination of both.

The term “unrelated applications” is defined as two or more applications that have no special permissions for sharing or managing data between (or among) them or are otherwise restricted from sharing or exchanging data in an unfettered or substantially unfettered and secure manner, either based on their construction or the environment in which they are installed (or both). For example, unrelated applications may be two or more applications that run as separate processes within an operating system. The term “file system” is defined as an abstraction that is used to organize, store and retrieve data. A “virtual file system” is a file system that presents an abstraction layer over a paste memory element and that one or more applications may access such that when one of the applications is active, that application may access the file system and when that application is deactivated, remove that access to the file system so that another application that becomes active may access the file system. The term “secure application” is defined as an application that has been modified to restrict communications between the application and unauthorized programs or devices, restrict operation of the application based on policy, or to alter, augment or add features associated with the operation of the application. The term “encryption engine” is defined as a component or a group of components that encrypt data, decrypt data or encrypt and decrypt data.

A “virtual private network” or “VPN” is defined as an arrangement, connection or configuration that extends a private or protected network over a public or unprotected network. The term “VPN module” is defined as a combination of hardware and/or software components that are used to encapsulate and/or decapsulate data that is intended to be or is carried over a VPN. The term “per-application basis” is defined as a state or arrangement in which applications are provided or enabled with one or more components or services on an individual basis. In the event that a definition from a previous application that has been incorporated by reference into this application conflicts with a definition in this application, the definition in this application takes precedence over the previous definition.

As explained earlier, some enterprises may require their employees or associates to use system-level VPNs when they work remotely. These VPNs, however, are forced on any application that may need to securely connect to an enterprise's network and setting it up for different applications is an inefficient process.

To overcome these issues, a method and system for sharing a VPN connection among applications is described herein. In particular, in an environment in which multiple applications exchange data through the use of the virtual file system, a VPN for a first application can be established, and it can be determined that the first application is deactivated. Upon the determination that the first application is deactivated, a state of the VPN can be saved in a shared memory through the virtual file system. It may also be determined that a second application is activated. A VPN connection can be established for the second application by resuming the saved VPN state through the virtual file system. In another arrangement, each application may include a VPN module, thereby enabling VPN connections to be realized for applications on an individual basis.

As such, VPN connections can be easily shared among multiple applications, which can increase efficiency for an end user. Moreover, because the VPN modules can be built into the applications, certain applications can be targeted for this feature, and these applications are not required to share a system-level VPN with other applications.

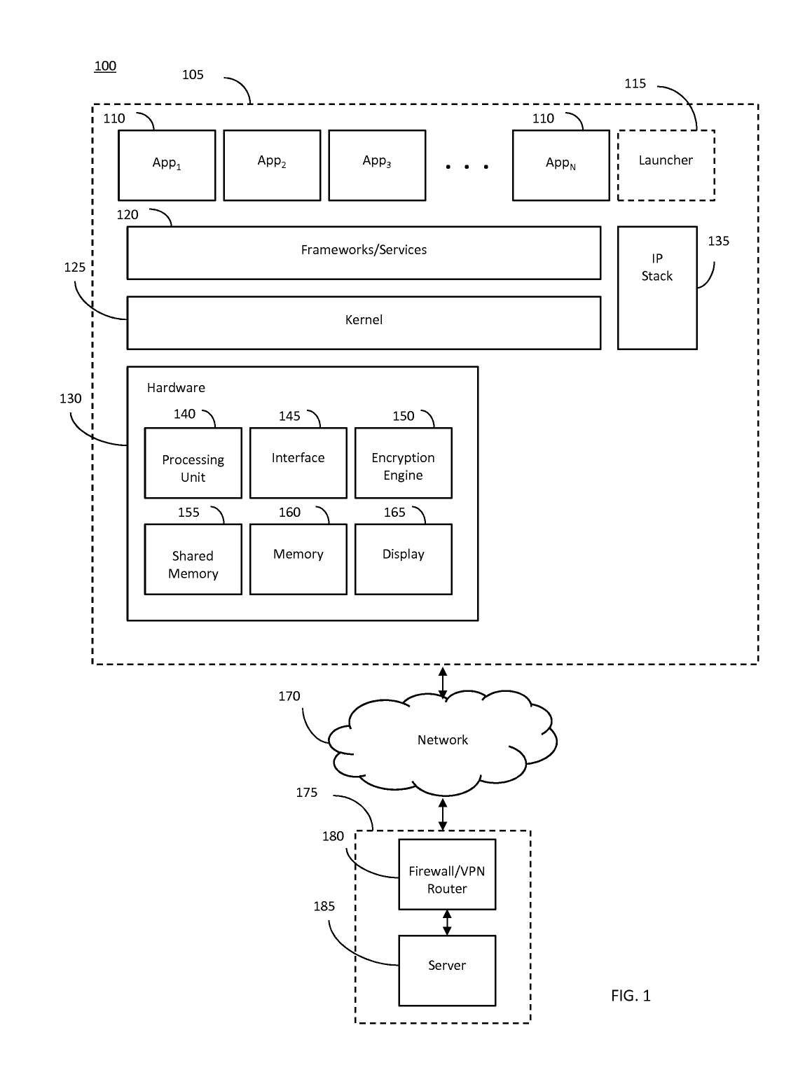

Referring to FIG. 1, an example of system 100 that enables the sharing of a VPN connection among applications is shown. A computing device 105 may be part of the system 100, and the device 105 may have one or more applications 110 installed on the device 105. As an option, the computing device 105 may include a launcher 115, which can be an application that may facilitate and/or control the launching and operation of the other applications 110. Examples of this process will be presented below.

As is known in the art, the computing device 105 may include a frameworks/services level 120 that provides several abstraction layers that include system interfaces and that facilitate operation of the applications 110 and other functions of the device 105. As is also known in the art, the computing device 105 can include a kernel 125, which provides interfaces for the frameworks/services level 120 to interact with a hardware layer 130. The computing device 105 may also be equipped with an IP stack 135, which, as will be explained later, can serve to facilitate VPN connections for the applications 110.

Several components may be considered part of the hardware layer 130, such as a processing unit 140, an interface 145, an encryption engine 150, shared memory 155, a persistent memory 160 and a display 165. The processing unit 140 can be communicatively coupled to any number of the components in the hardware layer 130 and may be responsible for controlling or directing their operations. In one arrangement, the interface 145 can be configured to enable communications between the computing device 105 and any external devices or networks, such as the network 170. In particular, the interface 145 can support wired or wireless communications, over local or wide area networks. In one non-limiting example, the interface 145 can be configured to support VPN connections for the computing device 105. As there are many different forms of communications and protocols, the computing device 105 can include any suitable number of interfaces 145.

Continuing with the hardware layer 130, the encryption engine 150 can be configured to encrypt and decrypt data or voice that is sent from or received by the computing device 105. Although shown as a separate component, the encryption engine 150 may be part of the processing unit 140 or some other suitable device. The shared memory 155 may be a memory element that is accessible by two or more applications 110 and that enables the applications 110 to exchange data with one another. As an example, the shared memory 155 may be a paste memory element or a pasteboard, a component that typically supports copy-and-paste operations, although other memory elements can serve as the shared memory 155. In one arrangement, the encryption engine 150 can encrypt data that is to be stored in the shared memory 155 and decrypt such data when retrieved from the memory 155. The computing device 105 can also include memory 160, which can be a persistent memory and can store data that is necessary for the operation of the computing device 105. The display 165 can display various objects to a user of the computing device 105 and can be configured to accept input from such a user. It is understood that the foregoing listing of components is not meant to be exhaustive, as the computing device 105 may include any suitable number and type of hardware components, including even fewer than are pictured here.

The system 100 may also include a network 170 and a remote facility 175. The network 170, for example, may be comprised of any suitable combination of components to enable any type of wireless or wired communications. In fact, the network 170 may comprise multiple networks, each working in tandem to support communications between the computing device 105 and the remote facility 175 or some other installation. As an example, the remote facility 175 may include a firewall/VPN router 180, which can be communicatively coupled to one or more servers 185. As will be described below, the system 100 supports protected communications between one or more computing devices 105 and one or more remote facilities 175.

In one example, the computing device 105 may be a managed device, which enables a party to control certain aspects of the device 105, including the type of content that may be delivered to the device 105. Earlier presentations have been provided that illustrate a solution that describes some of these techniques, such as in U.S. patent application Ser. No. 13/179,513, filed on Jul. 9, 2011, which is incorporated by reference herein in its entirety.

In another example, the applications 110 may be unrelated or sandboxed applications. That is, the computing device 105 may present an environment that restricts or substantially restricts communications among applications. The phrase “restricts communications” is defined as a condition in which the unfettered exchange of data is not available or applications may not have certain permissions for sharing or managing data with respect to another application or service and any communications that are permitted are not done in a secure manner. For example, a first unrelated application may not be able to freely exchange data with a second unrelated application and any exchanges that are allowed may be unprotected, or open to other unrelated applications. This condition may be based on the construction of the applications themselves, the rules of the environment in which the applications are operating or a combination of both.

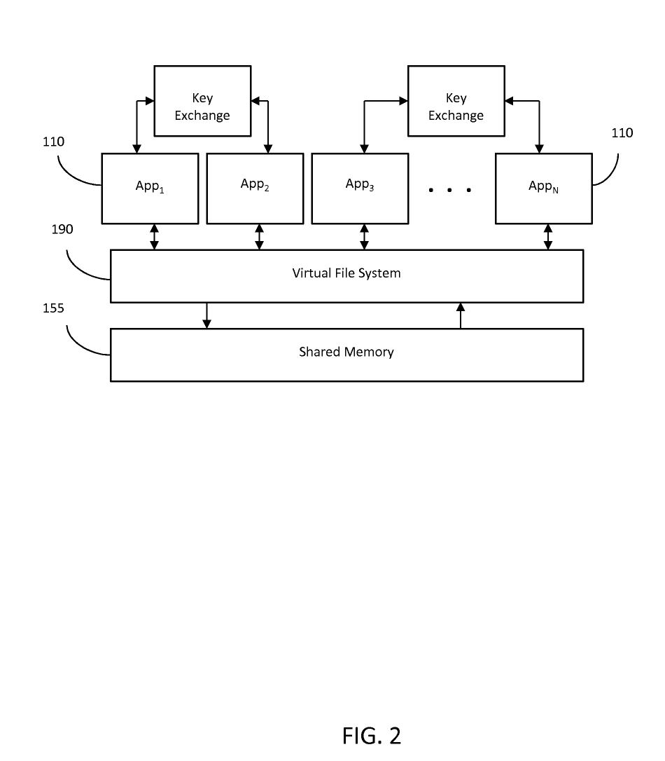

Referring to FIG. 2, one example of a solution for enabling data exchanges among applications in such an arrangement is shown. As can be seen, the shared memory 155 of the computing device 105 can have a file system 190 imposed on it. Any suitable structure for the file system 190 may be employed here. In one example, however, the file system 190 can be a block file system and can essentially segment the shared memory 155 into a plurality of data blocks for storing various types of data associated with the applications 110. The virtual file system 190 can present an abstraction layer to enable the applications 110 to interact with the shared memory 155 such that the applications 110 are not necessarily burdened with managing or overseeing the allocation of space in the shared memory 155. Thus, a virtual file system 190 is presented here that enables unrelated applications 110 to share data among one another.

As mentioned above, the shared memory 155 may be a paste memory element, such as a pasteboard. In some operating environments, it is possible to create custom memory elements for copying and pasting and to configure them as persistent memory elements, meaning that the data stored in them may survive reboots or other interruptions to the operation of the memory element. In one arrangement, any number of custom paste memory elements can be created to carry out the solutions presented herein, with the virtual file system being imposed on these elements. Moreover, these custom paste memory elements may be configured to be persistent memory elements. It is understood, however, that the shared memory 155 may be any suitable memory element and is not necessarily limited to being a paste memory or to being persistent in nature.

Because the shared memory 155 may be accessible by numerous applications 110, it may be desirable to encrypt the data that that the applications 110 store in the shared memory 155. Thus, only applications 110 that have been provide with the appropriate encryption keys may retrieve the encrypted data in the shared memory 155. To facilitate this process, the encryption keys that are generated may be exchanged among the applications 110. For example, if a first application App₁ is launched, a user or some other entity may be required to provide some type of verification information. A key can be generated based on the verification information that is provided, and this key can be used to carry out the encryption. If the user closes the first application App₁ and then re-launches it, this same key can be used to decrypt the data if it is retrieved from the shared memory 155. Similarly, if the user closes the first application App₁ following the encryption and writing of its data to the shared memory 155 and launches a second application App₂, the first application App₁ may share this key with the second application App₂ to enable the second application App₂ to obtain the encrypted data. In this case, it may not be necessary for the user (or other entity) to provide the verification information again. This key exchange may occur between any suitable number and type of applications 110, as represented in FIG. 2.

To address security concerns, however, some restrictions may be placed on this process. For example, an application 110 may be blocked from sharing a key with one or more other applications 110 or a time limit may be imposed on the sharing (or re-use) of that key. For example, once the first unrelated application App₁ is closed, a time period may begin to toll, such as one minute or some other predetermined amount of time. Of course, if desired, a more restrictive procedure may be used, and upon launch, each application 110 may be required to generate a key, i.e., no key sharing may be permitted. For additional information on virtual file systems, the sharing of data in reliance on such file systems and key exchanges for facilitating their operation, please see U.S. Patent Application No. 61/846,736, filed on Jul. 16, 2013 and U.S. patent application Ser. No. 13/942,042, filed on Jul. 15, 2013, each of which is herein incorporated by reference in its entirety.

Other steps may be taken to protect the data stored in the shared memory 155 and the applications 110. For example, in some operating environments, a derived and unpredictable namespace may be imposed on the shared memory 155, particularly if the shared memory 155 is a custom paste memory element created in the fashion previously described. In addition, the namespace may be imposed on the applications 110 that may have access to the shared memory 155. This namespace encapsulation may prevent unauthorized applications from accessing the data stored in the shared memory 155. For additional information on this process, please see U.S. patent application Ser. No. 13/626,470, filed on Sep. 25, 2012, which is herein incorporated by reference in its entirety.

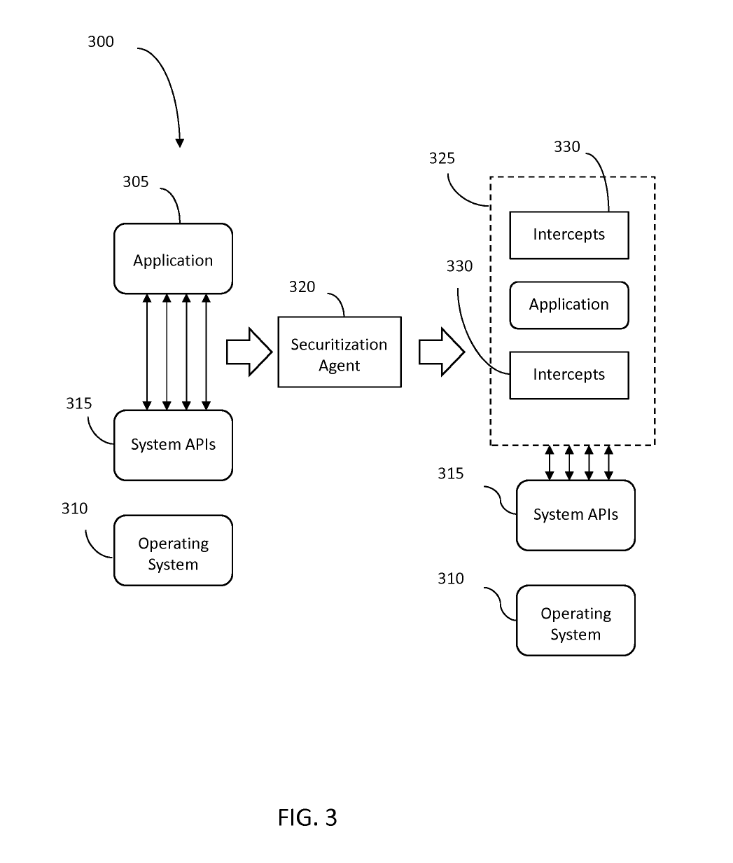

In one arrangement, at least some of the applications 110 on the computing device 105 may be secure applications. A secure application, as is known in the art, may be a conventional application that has been modified to enable the application to be managed in a certain way or to achieve new functionalities, a process commonly referred to as wrapping or securitizing an application. Referring to FIG. 3, a representation 300 of the wrapping or securitization process is illustrated. Here, a conventional or target application 305 is shown in which the target application 305 is developed for operating system 310 and calls system APIs 315. At this point, the target application 305 may be considered a non-secure application. The target application 305 can be submitted to a securitization agent 320, and the securitization agent 320 can subject the target application 305 to the wrapping process to generate a secure application 325. The securitization agent 320 can include any suitable number and type of software and hardware elements to carry out the securitization process.

In view of this procedure, the secure application 325 may still maintain its affiliation with the operating system 305 and may still call the system APIs 310. The overall utility of the secure application 325, however, is increased because one or more intercepts 330 may be interposed on the system APIs 310. These intercepts may be representative of any number of policies that are set forth by a party in control of the secure application 325 and of any new or modified functionalities that are realized from the wrapping process.

It is important to note that securitizing an application 110 does not just add a dynamic library to an executable by simply modifying the header of an executable, a process that is easily undone and may violate development agreements associated with the application; rather, it can repackage the application so that the injected code is physically inseparable from the original code. This method prevents secure applications that may be modified by third parties from running within a secure environment.

In addition, the wrapping or securitization process can preserve all the normal functions and APIs of a platform, while ensuring that protected information is handled securely. Application developers do not have to create applications or modify existing applications to accommodate this procedure and are not required to use any custom APIs or lose any functions associated with their applications. Calls to data sharing or data storage APIs may be automatically intercepted to ensure that sensitive enterprise data is handled appropriately. As such, secure applications may share data in the normal methods that are available on a given platform, but secure applications may not be able to share data with non-secure applications.

There are several ways to carry out the process of securing applications. The first scheme primarily focuses on byte-code injection, in which byte-code API calls are replaced with intercepts. As an example, this method is particularly applicable to—but certainly not limited to—certain applications formatted for the Android operating system developed by Google, Inc. of Mountain View, Calif. The second scheme chiefly centers on linking in replacement calls for native object code. This latter method is useful for applications that use native methods, such as Android applications that rely on native code (i.e., they do not run under a virtual machine) and applications developed for iOS, a mobile operating system developed by Apple, Inc. of Cupertino, Calif. Of course, other methods for creating a secure application may be employed here. Additional information on these concepts is presented in U.S. patent application Ser. No. 13/626,470, filed on Sep. 25, 2012, which is incorporated by reference herein in its entirety.

In one embodiment, the applications 110 may be re-mapped during the wrapping process to interact with and support the file system 190 that is imposed on the shared memory 155. For example, this process may include re-mapping the reading and writing commands of the application 110 to the file system 190. As previously noted, the namespace imposed on the shared memory 155 may also be imposed on the applications 155. This procedure can be carried out, for example, when the applications 110 undergo the wrapping process. The use of secure applications and namespace enforcement can also facilitate the sharing of keys for the encryption/decryption of data described above. That is, these schemes can ensure that only authorized applications may be part of a secure workspace that provides access to a common memory element and a virtual file system for accessing the element, which presents a much safer environment for sharing keys.

Although applications that are secure applications may take advantage of the principles presented herein, this description is not so limited. That is, it is important to note that applications that have not undergone the wrapping process may exchange data with one another using a file system imposed on a shared memory element.

There are several other principles that should be addressed here. In particular, it is not necessary to impose a file system on the shared memory 155. That is, applications 110 that wish to exchange data may do so using the shared memory 155 without the use of the file system 190. Moreover, applications 110 that can take advantage of data exchange using the shared memory 155, with or without the file system 190, do not have to be unrelated to one another. That is, any application 110 may provide encrypted data to the shared memory 155, and any other authorized application 110 may access and decrypt the data. This concept applies to both secure and unsecure applications and related and unrelated applications.

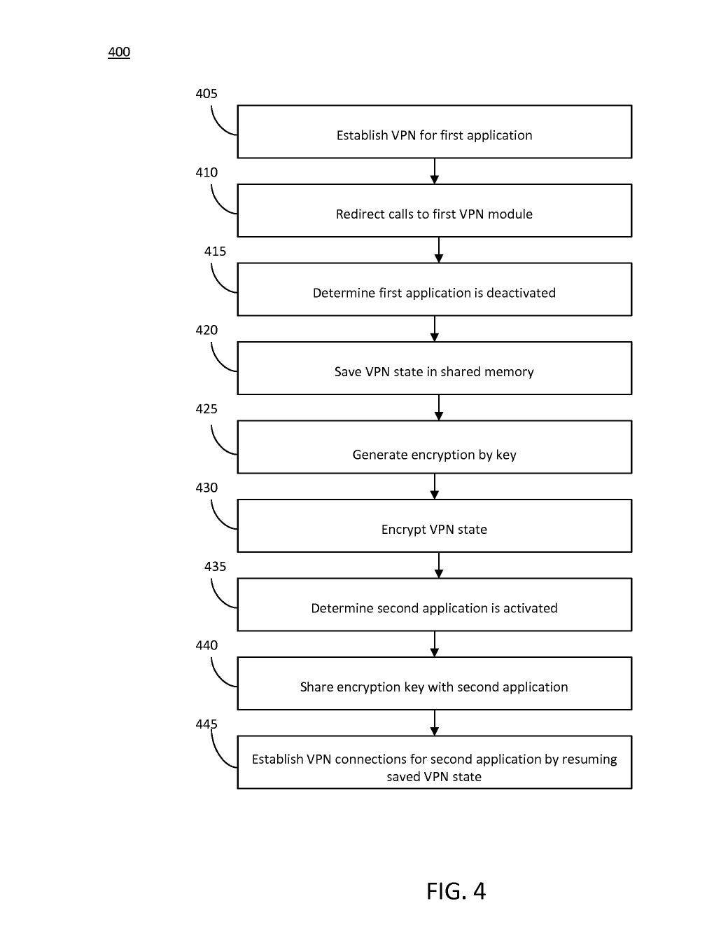

In certain cases, it may be advantageous to incorporate VPN functionality into individual applications 110. Moreover, it may be useful to enable the sharing of a VPN connection among several applications 110. Referring to FIG. 4, a method 400 that illustrates an example of how such a process may be achieved is presented. It is important to note, however, that the method 400 may include additional or even fewer steps or processes in comparison to what is illustrated in FIG. 4. Moreover, the method 400 is not necessarily limited to the chronological order that is shown in FIG. 4. In describing the method 400, reference may be made to FIGS. 1-3, although it is understood that the method 400 may be practiced with any other suitable systems and components and may take advantage of other suitable processes.

At step 405, a VPN can be established for a first application, and at step 410, calls can be redirected to a first VPN module of the first application. To explain this process, reference will be made to the material previously discussed. In particular, as noted above, the applications 110 may be secure applications, and as such, the functionality of the applications 110 can be enhanced. As an example, a VPN module can be incorporated into one or more of the applications 110, such as when these applications 110 undergo the securitization process. Because the VPN modules can be implemented in the applications 110 on an individual basis, an entity can determine which applications 110 are to be provided with the ability to conduct communications over a VPN connection at the application layer.

In conventional systems, a VPN module typically resides at the system level, and the packet data that needs to be encapsulated exists in the lower layers of the system architecture. To enable the operation of a VPN connection at the application layer, an IP stack 135 (see FIG. 1) can be used to redirect the packet data from the lower layers of the system in the computing device 105 to a VPN module that is part of an application 110. Specifically, hooks can be integrated into certain functions of the lower levels of the software architecture where the packet data is typically processed for VPN communications, and they can be redirected into the IP stack 135. Thus, these calls—such as connect, read, and write—can be intercepted, and the related packet data can be redirected to the VPN module of the relevant application 110. The VPN module can then encapsulate the packet data for delivery to (or decapsulate the packet data once received from) another component.

In one example, the VPN connection from the application 110 may be directed to the remote facility 175, which can enable the application 110 to have protected communications (over the network 170) with the server 185 or with some other device that is associated with the remote facility 175. The connection between the computing device 105 and the remote facility 175 can operate in accordance with any suitable protocol(s). As an example, one of the protocols that can be employed is user datagram protocol (UDP).

Referring back to the method 400, at step 415, it can be determined when the first application is deactivated. At step 420 a state of the VPN can be saved in a shared memory. An encryption key can be generated, as shown at step 425, and the VPN state can be encrypted for storage in the shared memory, as shown at step 430.

For example, the first application 110 with the open VPN connection may be deactivated. By being deactivated, an application 110 may be closed, in the process of closing, or at least arranged such that it is not currently presented to the user, like being moved to the background. Deactivation of an application 110 may also include the initial receipt of some input from a user or a component that indicates that the application 110 is to be closed or moved to the background.

Once it is determined that the application 110 is deactivated, a state of the VPN for the application 110 can be saved, such as in the shared memory 155 through the virtual file system 190. The state of the VPN can include any suitable information related to the current VPN connection for the application 110. Examples include connection and encryption information related to the VPN, although other data may be part of this arrangement. As will be explained later, by storing this information, a second application 110 may retrieve this information from the shared memory 155, and the information can be used when a VPN connection is established for that second application 110.

As part of saving the VPN state, the application 110 or some other component may generate an encryption key, which can be used to encrypt the VPN state for storage in the shared memory 155. This step can prevent an unauthorized process from retrieving the VPN state. Although the VPN state can be encrypted prior to be stored in the shared memory 155, the process can be configured such that the encryption of the data occurs after it is stored in the shared memory 155.

Referring once again to the method 400, at step 435, it can be determined when a second application is activated, and at step 440, an encryption key can be shared with the second application. In addition, at step 445, a VPN connection can be established for the second application by resuming the saved VPN state.

For example, it can be determined when a second application 110 is activated. By being activated, the application has been launched and is being presented to the user for use or is currently being used by the user (i.e., it is not running in the background) or some process has been initiated to put that application in such a state. In response, the encryption key that was used to encrypt the VPN state that is saved in the shared memory 155 can be shared with the second application 110. As such, the second application 110 can retrieve the saved VPN state and decrypt it. At this point, if a VPN connection is necessary for the second application 110, the second application 110 can resume the saved VPN state to enable the connection. By resuming the saved VPN state, the second application 110 is not required to perform a VPN initiation process, thereby presenting a more efficient way to establish the VPN connection. This process can be repeated for any other suitable application 110.

In one arrangement, when an application 110 is activated, the VPN connection can be automatically established such that any type of communications that relate to that application 110 will be protected, depending on the type of protocols that are supported by the VPN. In another arrangement, the use of the VPN for the application 110 may be selective, which can permit a user or the application 110 to choose when the VPN connection is to be established.

As noted above, the computing device 105 may have a launcher 115, and in some environments, this launcher 115 can be used to facilitate the sharing of the VPN state. For example, when a first application 110 is deactivated, the first application 110 may provide the VPN state to the launcher 115, and the launcher 115 may store the VPN state in a dedicated memory. When a second application 110 is activated and a VPN connection needs to be established for the second application 110, the launcher 115 can provide the saved VPN state to the second application 110 for the VPN connection. The second application 110 can then resume the VPN state. In this arrangement, the VPN state can be encrypted for storage in the dedicated memory, although the launcher 115 may be responsible for encrypting and decrypting the information. As such, the sharing of encryption keys may not be necessary here.

In other cases, a shared counter may be used in which packets are counted for each process, and the shared counter may be stored in a shared memory, which may be accessible by multiple applications 110. The use of a shared counter may be useful in preventing replay attacks. In one instance, the launcher 115 can be used to coordinate the use of the shared counter. Moreover, there may be a listing of applications 110 that are authorized to use the saved VPN state and the counter, and the launcher 115 can check this list to ensure that a requesting application 110 is authorized before the launcher 115 provides this information.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

1. A method of providing a virtual private network (VPN) on a per-application basis, comprising:
launching a first application on a computing device;
establishing a VPN connection for the first application through a VPN module that is part of the first application;
deactivating the first application;
launching a second application on the computing device;
establishing a VPN connection for the second application through a VPN module that is part of the second application; and
as part of establishing the VPN connection for the second application, using the state of the VPN associated with the first application.

2. A method for sharing a virtual private network (VPN) connection among applications, comprising:
in an environment in which multiple applications exchange data through the use of the virtual file system, establishing a VPN for a first application;
determining that the first application is deactivated;
upon the determination that the first application is deactivated, saving a state of the VPN in a shared memory through the virtual file system;
determining that a second application is activated; and
establishing a VPN connection for the second application by resuming the saved state of the VPN through the virtual file system.

3. The method according to claim 1, wherein the shared memory is a pasteboard that is accessible by the first and second applications and the virtual file system is imposed over the pasteboard.

4. The method according to claim 1, wherein the first application and the second application are unrelated secure applications.

5. The method according to claim 1, wherein establishing the VPN for the first application and establishing the VPN for the second application comprises establishing the VPN for the first application and establishing the VPN for the second application on a per-application basis.

6. The method according to claim 4, further comprising redirecting calls originally intended for a system-level VPN to a first VPN module of the first application when the VPN for the first application is established and to a second VPN module of the second application when the VPN for the second application is established.

7. The method according to claim 1, wherein by resuming the saved VPN state, the second application is not required to perform a VPN initiation process.

8. The method according to claim 1, further comprising encrypting the VPN state prior to saving the VPN state in the shared memory.

9. The method according to claim 7, further comprising:
generating an encryption key for encrypting the VPN state prior to saving the VPN state in the shared memory; and
sharing the encryption key with the second application to enable the second application to decrypt the saved VPN state.

10. A method of sharing a virtual private network (VPN) connection among applications, comprising:
establishing the VPN connection from a first application to a server;
redirecting packet data to a VPN module that is part of the first application to enable communications over the VPN connection from the first application to the server;
saving a state of the VPN in a shared memory when the first application is deactivated; and
establishing a VPN connection for a second application by resuming the saved VPN state.

11. The method according to claim 9, further comprising redirecting packet data to a VPN module that is part of the second application to enable communications over the VPN connection from the second application.

12. The method according to claim 9, wherein the first application and the second application are secure applications.

13. The method according to claim 9, wherein the first application is a secure application and establishing the VPN connection for the second application further comprises establishing the VPN connection for the second application by resuming the saved VPN state only if the second application is a secure application.

14. The method according to 9, wherein the shared memory is a pasteboard and a virtual file system is imposed over the pasteboard.

15. The method according to claim 9, further comprising encrypting the state of the VPN prior to storing the state of the VPN in the shared memory.

16. A computing device that supports per-application virtual private networks (VPN), comprising:
an interface that is configured to support a VPN connection to a server; and
a shared memory that is accessible by a first application and a second application that are both installed on the computing device, wherein the shared memory is configured to store a VPN state when the first application is deactivated and the VPN state is related to a VPN connection for the first application;
wherein the shared memory is further configured to provide the stored VPN state to the second application when the second application is activated and a VPN connection for the second application is to be established.

17. The computing device according to claim 15, further comprising an encryption engine that is configured to encrypt the VPN state prior to the VPN state being stored in the shared memory.

18. The computing device according to claim 15, wherein the shared memory is a pasteboard and a virtual file system is imposed over the pasteboard, wherein the first and second applications use the virtual file system to access the pasteboard.

19. The computing device according to claim 15, wherein the first and second applications are secure applications and the computing device is configured to isolate the secure applications from non-secure applications.

20. The computing device according to claim 18, wherein the first and second applications are unrelated applications.

21. The computing device according to claim 15, further comprising a processing unit that is configured to enable packet data to be redirected to a VPN module that is part of the first application when the VPN connection is established for the first application and to a VPN module that is part of the second application when the VPN connection is established for the second application.
